(19) United States
(12) Patent Application Publication
(10) Pub. No.: US 2026/0170169 A1
(43) Pub. Date: Jun. 18, 2026

(54) METHOD AND APPARATUS FOR IDENTIFYING PERSONAL INFORMATION FROM TEXT USING A MULTI-STAGE DETECTION APPROACH

(71) Applicant: S2W INC., Seongnam-si (KR)

(72) Inventors: In Wook HWANG, Seongnam-si (KR); Keun Tae PARK, Seoul (KR)

(73) Assignee: S2W INC., Seongnam-si (KR)

(21) Appl. No.: 18/987,173

(22) Filed: Dec. 19, 2024

(30) Foreign Application Priority Data
Dec. 13, 2024 (KR) 10-2024-0186173

(51) Int. Cl. G06F 21/62; G06F 40/216

(52) U.S. Cl. CPC G06F 21/6245; G06F 40/216

(57) ABSTRACT

Provided is a text-based personal information identification method utilizing multi-stage detection, which includes receiving identification target data including text, performing a first detection to determine whether personal information is non-existent in the identification target data based on pattern matching, allowing the identification target data to pass when it is determined in the first detection that the personal information is non-existent, and performing a second detection to determine whether personal information exists in the identification target data using a large language model (LLM) when it is determined in the first detection that the personal information is not non-existent.

### CROSS-REFERENCE TO RELATED APPLICATION

This application claims priority to and the benefit of Korean Patent Application No. 10-2024-0186173, filed on Dec. 13, 2024, the disclosure of which is incorporated herein by reference in its entirety.

### BACKGROUND

### 1. Field of the Invention

The present disclosure relates to a text-based personal information identification method and apparatus using multi-stage detection.

### 2. Discussion of Related Art

Personal information protection is emerging as a critical issue in the modern information society, and accordingly, technologies that automatically detect and protect personal information are being demanded in various fields.

Personal information is commonly expressed as text-based data, but when personal information is mixed with various and extensive information such as messaging conversations or reports, it is difficult to accurately identify the personal information.

Conventionally, pattern matching techniques have been used for detecting personal information. These techniques identify personal information such as names, addresses, phone numbers, and resident registration numbers from text by utilizing predefined rules or keyword sets.

This conventional method is a method for detecting pre-established personal information types from text using regular expressions. When the personal information corresponds exactly to the regular expressions, the personal information can be quickly identified, but the conventional method has a limitation in that its accuracy is not high for various expressions in real life where the personal information does not correspond to the regular expressions.

### RELATED ART DOCUMENT

### Patent Document

Korean Patent Registration No. 10-2668190 (Registration date May 17, 2024)

### SUMMARY OF THE DISCLOSURE

The present disclosure is directed to a text-based personal information identification method and apparatus using multi-stage detection, which can quickly and accurately identify personal information by utilizing a pattern matching technique and a large language model (LLM) in a multi-stage combinatorial detection operation.

The present disclosure is also directed to a text-based personal information identification method and apparatus using multi-stage detection, which can quickly identify and provide a plurality of pieces of information that are not personal information by applying a detection pattern matching method in a first detection to quickly identify non-personal information in the first detection and allow the identified non-personal information to pass without a second detection.

The present disclosure is also directed to a text-based personal information identification method and apparatus using multi-stage detection, which can accurately identify personal information that deviates from a specific pattern as personal information by utilizing an LLM in a second detection to identify personal information.

The present disclosure is also directed to a text-based personal information identification method and apparatus using multi-stage detection, which can improve the identification accuracy of personal information based on a multi-stage combinatorial detection without being limited to a specific detection method by combining a plurality of pattern detection methods to configure a first detection.

However, the problem to be solved in the present disclosure is not limited to the problem mentioned above, and may be variously expanded within a scope that does not deviate from the spirit and scope of the present disclosure.

According to an aspect of the present disclosure, there is provided a text-based personal information identification method utilizing multi-stage detection. The method includes: receiving identification target data including text; performing a first detection to determine whether personal information is non-existent in the identification target data based on pattern matching; allowing the identification target data to pass when it is determined in the first detection that the personal information is non-existent; and performing a second detection to determine whether personal information exists in the identification target data using an LLM when it is determined in the first detection that the personal information is not non-existent.

In one embodiment, the text-based personal information identification method may further include, when it is determined that the personal information is included in the identification target data according to a result of the second detection, performing post-processing for security on the personal information.

In one embodiment, the performing of the first detection may include applying a probabilistic language model to the identification target data to determine whether personal information is non-existent in the identification target data.

In one embodiment, the applying of the probabilistic language model may include calculating an evaluation index for a next word based on the context up to a current word of the identification target data using the probabilistic language model, the evaluation index being an evaluation index related to linguistic probability; and identifying the next word as personal information when the evaluation index exceeds a predetermined threshold.

In one embodiment, the applying of the probabilistic language model may include setting the next word as the current word when the evaluation index does not exceed the predetermined threshold.

In one embodiment, the evaluation index may be perplexity in the probabilistic language model.

In one embodiment, the performing of the first detection may further include determining whether personal information is non-existent in the identification target data using a regular expression-based rule.

In one embodiment, the determining of whether personal information exists in the identification target data using a regular expression-based rule may include pre-setting the regular expression-based rule; determining whether a substring corresponding to a predetermined rule exists in the identification target data; and identifying the substring as personal information when it is determined that the substring exists in the identification target data.

According to another aspect of the present disclosure, there is provided a text-based personal information identification apparatus. The apparatus includes: at least one processor; and a memory configured to store instructions, wherein the instructions may cause, when individually or collectively executed by the at least one processor, the processor to receive identification target data including text, perform a first detection to determine whether personal information is non-existent in the identification target data based on pattern matching, allow the identification target data to pass when it is determined in the first detection that the personal information is non-existent, and perform a second detection to determine whether personal information exists in the identification target data using an LLM when it is determined in the first detection that the personal information is not non-existent.

According to still another aspect of the present disclosure, there is provided a storage medium. The storage medium is a storage medium storing computer-readable instructions, wherein the instructions, when executed by a computing device, cause the computing device to perform operations of: receiving identification target data including text; performing a first detection to determine whether personal information is non-existent in the identification target data based on pattern matching; allowing the identification target data to pass when it is determined in the first detection that the personal information is non-existent; and performing a second detection to determine whether personal information exists in the identification target data using an LLM when it is determined in the first detection that the personal information is not non-existent.

### BRIEF DESCRIPTION OF THE DRAWINGS

FIG. 1 is a diagram illustrating a text-based personal information identification system using multi-stage detection according to one embodiment of the present disclosure.

FIG. 2 is a conceptual diagram illustrating a text-based personal information identification apparatus using multi-stage detection according to one embodiment of the present disclosure.

FIG. 3 is a flowchart illustrating a text-based personal information identification method using multi-stage detection according to one embodiment of the present disclosure.

FIG. 4 is a block diagram illustrating a text-based personal information identification apparatus using multi-stage detection according to one embodiment of the present disclosure.

FIG. 5 is a flowchart illustrating a text-based personal information identification method using multi-stage detection performed in the personal information identification apparatus illustrated in FIG. 4 according to one embodiment of the present disclosure.

FIG. 6 is a block diagram illustrating a first detection module according to one embodiment of the present disclosure.

FIG. 7 is a flowchart illustrating an example of a personal information identification method using rule-based detection performed in a first detection module according to one embodiment of the present disclosure.

FIG. 8 is a flowchart illustrating an example of a personal information identification method using a probabilistic language model performed in a first detection module according to an embodiment of the present disclosure.

FIG. 9 is a reference diagram illustrating an example of a personal information identification method using a probabilistic language model.

FIG. 10 is a flowchart illustrating an example of a personal information identification method using a large language model (LLM) performed in a second detection module according to one embodiment of the present disclosure.

FIG. 11 and FIG. 12 are reference diagrams illustrating examples of a personal information identification method using an LLM.

FIG. 13 is a block diagram illustrating a text-based personal information identification server using multi-stage detection according to one embodiment of the present disclosure.

### DETAILED DESCRIPTION OF EXEMPLARY EMBODIMENTS

Hereinafter, with reference to the drawings, embodiments of the present disclosure will be described in detail so that those skilled in the art can easily implement the present disclosure. However, the present disclosure may be implemented in various different forms and is not limited to the embodiments described herein. In relation to the description of the drawings, the same or similar reference numerals may be used for the same or similar components. In addition, in the drawings and related descriptions, descriptions of well-known functions and configurations may be omitted for clarity and conciseness.

Various embodiments of this disclosure and terms used therein are not intended to limit the technical features described in this disclosure to specific embodiments, and should be understood to include various modifications, equivalents, or alternatives of the embodiments. In relation to the description of the drawings, similar reference numerals may be used for similar or related components. The singular form of a noun corresponding to an item may include one item or a plurality of items, unless the relevant context clearly dictates otherwise. In this disclosure, phrases such as “A or B,” “at least one of A and B,” “at least one of A or B,” “A, B or C,” “at least one of A, B and C,” and “at least one of A, B, or C” may include any one of the items listed together in the corresponding phrase among those phrases, or all possible combinations of the items. Terms such as “first,” “second,” or“firstly,” “secondly” may simply be used to distinguish a corresponding component from other corresponding components, and unless specifically stated to the contrary, do not limit the corresponding components in other respects (e.g., importance or order). In this disclosure, if a certain (e.g., first) element is referred to as being “linked,” “combined,” “accessed,” “connected,” or “coupled” with or without the terms “functionally” or “communicatively” to another (e.g., second) component, it means that the certain component can be connected to the other component directly (e.g., in a wired manner), wirelessly, or through a third component.

The term “module” used in various embodiments of this document may include a unit implemented as hardware, software, or firmware and may be interchangeably used with a term such as “logic,” “logical block,” “part,” or “circuit.” The module may be an integrated part, or a minimum unit of the part or a part thereof, which performs one or more functions. For example, according to an embodiment, the module may be implemented in the form of an application-specific integrated circuit (ASIC).

The term “and/or” used in various embodiments of this document is used to encompass both the “and” condition and the “or” condition. For example, “A and/or B” means not only “A and B,” but also “A or B.”

Various embodiments of this document may be implemented as software (for example, a program) including one or more commands stored in a storage medium that may be read by a machine or device. For example, a processor of the machine or device may call at least one command among one or more commands stored in the storage medium, and may execute the command. This enables the machine to be operated to perform at least one function according to at least one called command. The one or more commands may include a code generated by a compiler or a code executable by an interpreter. The machine-readable storage medium may be provided in the form of a non-transitory storage medium. Here, “non-temporary” only means that the storage medium is a tangible device and does not include a signal, and this term does not discriminate a case where data is stored semi-permanently in the storage medium and a case where data is temporarily stored therein.

According to one embodiment, the method according to various embodiments disclosed in this document may be included and provided in a computer program product. The computer program product may be traded as a product between a seller and a purchaser. The computer program product may be distributed in the form of a device-readable storage medium (for example, a compact disc read only memory (CD-ROM)), or may be directly distributed (for example, downloaded or uploaded) online through an application store or between two user devices (for example, smartphones). In the case of online distribution, at least some of the computer program products may be temporarily stored or temporarily generated in a device-readable storage medium such as a memory of a manufacturer's server, an application store server, or a relay server.

According to various embodiments, each component (for example, module or program) of the components described above may include a singular object or a plurality of objects. According to various embodiments, one or more components or operations among the aforementioned components may be omitted, or one or more other components or operations may be added. Alternatively or additionally, a plurality of components (for example, modules or programs) may be integrated into a single component. In this case, the integrated component may perform one or more functions of each of the plurality of components identically or similarly to those performed by the corresponding component of the plurality of components prior to the integration. According to various embodiments, operations performed by modules, programs, or other components are executed sequentially, in parallel, iteratively, or heuristically, or one or more of the operations are executed in a different order or omitted, or one or more other operations may be added.

The processor in the present disclosure may be hardware capable of performing functions and operations according to each name described in the present specification, may be computer program code capable of performing specific functions and operations, or may be an electronic recording medium loaded with computer program code capable of performing specific functions and operations. The processor may be a functional and/or structural combination of hardware for performing the technical idea of the present disclosure and/or software for driving the hardware.

A large language model (hereinafter referred to as “LLM”) in the present disclosure may be a language model capable of performing a natural language processing (NLP) task.

A text-based personal information identification apparatus in the present disclosure may be defined and/or referred to as a text-based personal information identification server or service server, which may mean one physically independent server, but is not limited thereto. The text-based personal information identification apparatus may also be one virtual machine, and may be configured to encompass one module, program, or docker operating on one virtual or physical machine.

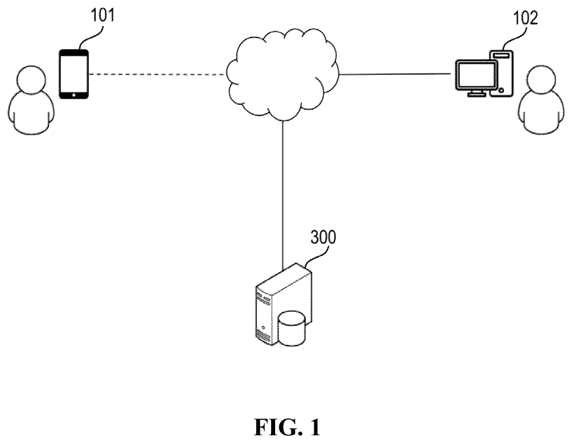

FIG. 1 is a diagram illustrating a text-based personal information identification system using multi-stage detection according to one embodiment of the present disclosure.

In FIG. 1, a text-based personal information identification system using multi-stage detection may include a text-based personal information identification apparatus 300 (hereinafter abbreviated as “personal information identification apparatus”) using multi-stage detection and at least one user device 101 and 102.

The personal information identification apparatus 300 may automatically detect personal information when exchanging data between the user devices 101 and 102, and take measures to prevent the personal information from being exposed.

The user transmits and posts identification target data through the user device 101 or 102.

The user device 101 or 102 is a device used by the user. For example, the user can be communicatively connected to the personal information identification apparatus 300 through the user device 101 or 102. The user device 101 or 102 may include various devices such as a smart device (e.g., a smartphone), a personal computer (PC), or a portable laptop computer, which may include an application 210 (or program).

The personal information identification apparatus 300 may receive the identification target data and perform a two-step detection on the identification target data to identify whether personal information exists in the identification target data.

The personal information identification apparatus 300 may use a first detection based on pattern matching and a second detection using an LLM in combination.

For example, the first detection based on pattern matching here may be a method for determining the non-existence of personal information in the identification target data, while the second detection using the LLM may be a method for determining the existence of personal information in the identification target data.

The identification target data is data including text, and the following description assumes a case where the personal information is text. Depending on the embodiment, the personal information may be displayed as an image, but it is obvious that even in this case, the personal information can be converted into text through optical character recognition (OCR), etc.

Hereinafter, it is assumed that the personal information identification apparatus 300 identifies and protects personal information in the case of data exchange such as a conversation or email exchange between two user devices 101 and 102. However, it is not limited thereto, and various embodiments according to the present disclosure can be applied in various environments such as when a user posts, announces, or transmits data to an unspecified target.

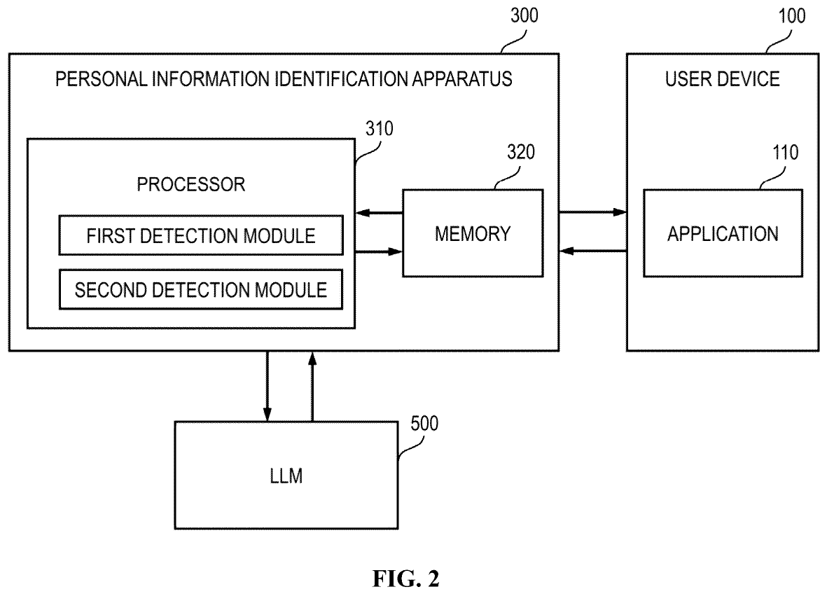

Hereinafter, with reference to FIGS. 2 to 12, a text-based personal information identification apparatus and method using multi-stage detection according to various embodiments of the present disclosure will be described.

FIG. 2 is a conceptual diagram illustrating a text-based personal information identification apparatus using multi-stage detection according to one embodiment of the present disclosure.

The personal information identification apparatus 300 may include a processor 310 and a memory 320.

The personal information identification apparatus 300 may further include a communication module for being communicatively connected to the user device 100 via wireless communication or wired communication. The communication module may include communication circuitry.

The processor 110 may include, for example, at least one of a microprocessor, a central processing unit, a processor core, a multi-core processor, a multiprocessor, an application-specific integrated circuit (ASIC), or a field programmable gate array (FPGA), but is not limited thereto.

The personal information identification apparatus 300 may include a plurality of detection modules for personal information detection. These detection modules may be artificial intelligence models or software modules which are individually operated, and may be implemented as portions of the processor 110, but are not limited thereto, and a separate processor may be used for each module.

The memory 120 may store instructions (or programs) executable by the processor 110. The memory 120 may include a volatile memory or a nonvolatile memory. The volatile memory can be implemented as a dynamic random access memory (DRAM), a static random access memory (SRAM), a thyristor RAM (T-RAM), a zero capacitor RAM (Z-RAM), or a twin transistor RAM (TTRAM). The nonvolatile memory can be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

The user device 100 is a device used by the user, and the user can be communicatively connected to the personal information identification apparatus 300 through the user device 100. The user device 100 may include various devices such as a smart device (e.g., a smartphone), a PC, or a portable laptop computer, and may include an application 110 (or a program).

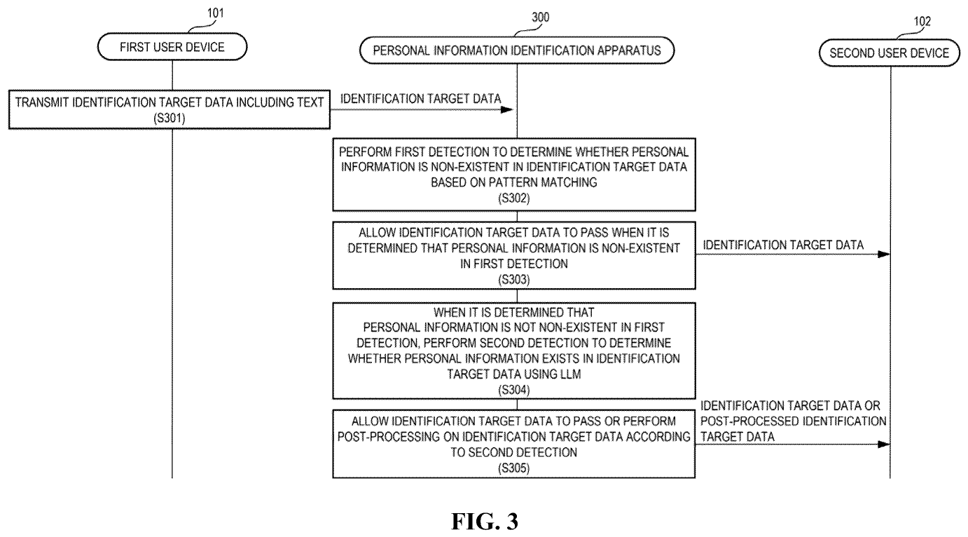

FIG. 3 is a flowchart illustrating a text-based personal information identification method using multi-stage detection according to one embodiment of the present disclosure.

In operation S301, The first user device 101 may generate identification target data including text and transmit the generated identification target data to the personal information identification apparatus 300.

The personal information identification apparatus 300 may receive the identification target data and perform personal information identification on the identification target data.

In operation S302, the personal information identification apparatus 300 may perform a first detection to determine whether personal information is non-existent in the identification target data based on pattern matching.

In operation S303, the personal information identification apparatus 300 may allow the identification target data to pass when it is determined that the personal information is non-existent in the first detection. Accordingly, the identification target data can be provided to the second user device 102 that is a transmission target.

In operation S304, when it is determined that personal information is not non-existent in the first detection, the personal information identification apparatus 300 may perform a second detection to determine whether personal information exists in the identification target data using an LLM.

In operation S305, when it is determined that personal information is included in the identification target data, the personal information identification apparatus 300 may perform post-processing for security on the personal information.

For example, when it is determined that the personal information is not included in the identification target data as a result of the second detection, the personal information identification apparatus 300 may transmit the identification target data as is to the second user device 102. When it is determined that the personal information is included in the identification target data, the personal information identification apparatus 300 may perform post-processing for security on the personal information, and transmit the post-processed identification target data to the second user device 102.

As described above, the personal information identification apparatus 300 can identify the existence or non-existence of personal information more quickly by combining the first detection based on pattern matching and the second detection based on the LLM.

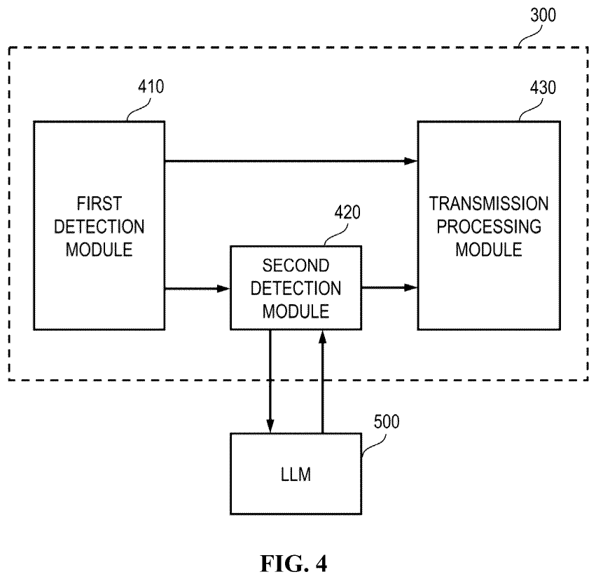

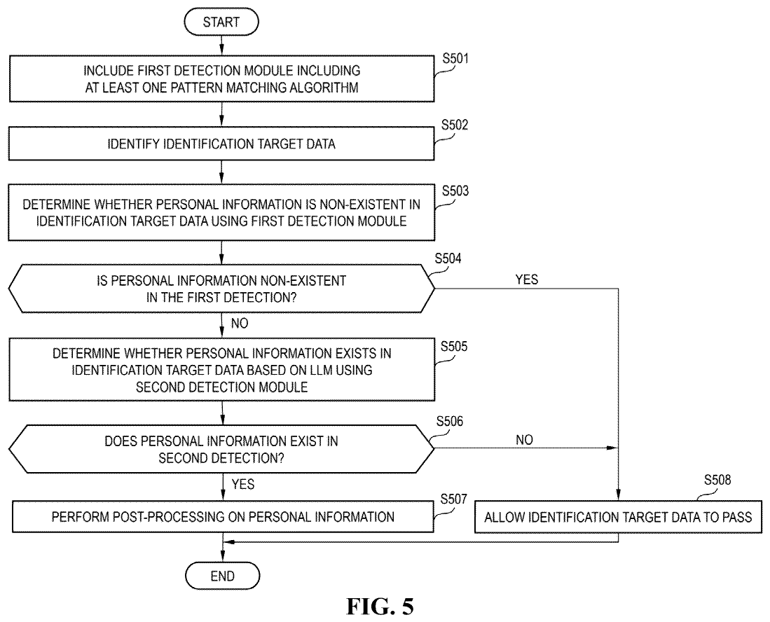

FIG. 4 is a block diagram illustrating a text-based personal information identification apparatus using multi-stage detection according to one embodiment of the present disclosure, and FIG. 5 is a flowchart illustrating a text-based personal information identification method using multi-stage detection performed in the personal information identification apparatus illustrated in FIG. 4 according to one embodiment of the present disclosure.

Referring to FIGS. 4 and 5, the text-based personal information identification apparatus 300 may include a first detection module 410, a second detection module 420, and a transmission processing module 430.

In operation S501, the first detection module 410 may implement at least one pattern matching algorithm, and may previously include, for example, a rule-based pattern matching algorithm, a language probability model-based matching algorithm, etc.

When the first detection module 410 identifies the identification target data in operation S502, the first detection module 410 may perform a first detection on personal information based on pattern matching to determine whether personal information is non-existent in the identification target data in operation S503.

When personal information is found to be non-existent as a result of the first detection of the first detection module 410 (YES in operation S504), the transmission processing module 430 may allow the corresponding identification target data to pass in operation S508. That is, the second detection process can be omitted.

On the other hand, when personal information is found not to be non-existent as the result of the first detection of the first detection module 410 (NO in S504), that is, when it is determined that personal information exists or there is a predetermined probability or higher that personal information exists, the second detection is performed.

In operation S505, the second detection module 420 may determine whether personal information exists in the identification target data based on an LLM.

In the example of FIG. 4, the second detection module 420 is illustrated as determining whether personal information exists in the identification target data by linking with an external LLM 500 such as ChatGPT, but is not limited thereto. Therefore, depending on the embodiment, various modifications can be implemented, such as linking with an individually trained LLM.

When personal information is found to exist as a result of the second detection of the second detection module 420 (YES in operation S506), the transmission processing module 430 may perform post-processing on the personal information in operation S507.

For example, various post-processing for personal information protection can be applied, such as deleting or partially deleting personal information, providing an alarm for the transmission of personal information to a first user, or providing the related information to an administrator.

When personal information is found not to exist as the result of the second detection of the second detection module 420 (NO in operation S506), the transmission processing module 430 may allow the corresponding identification target data to pass in operation S508.

Here, in the first detection based on pattern matching, the non-existence of personal information is determined. Here, the determination of the non-existence means that it is certain that there is no personal information or that there is a predetermined probability—for example, a threshold probability—or higher that there is no personal information. This is to enable the identification target data to pass immediately without the second detection when it is determined that personal information is non-existent, and through this, it is possible to quickly determine the existence or non-existence of personal information even in cases where rapid transmission is essential such as in real-time conversation.

Meanwhile, in the first detection based on pattern matching, when it is determined that personal information is not non-existent, it means that the certainty of non-existence of personal information is insufficient. In this case, the non-existence of personal information is more accurately identified. That is, a second detection process is performed using the LLM to identify whether personal information exists in the identification target data. Although this second detection process may introduce some latency from query to result, the second detection can significantly improve accuracy by identifying text related to personal information with near-human-level precision.

In this way, personal information can be detected more quickly and accurately by using a combined method of the first and second detections.

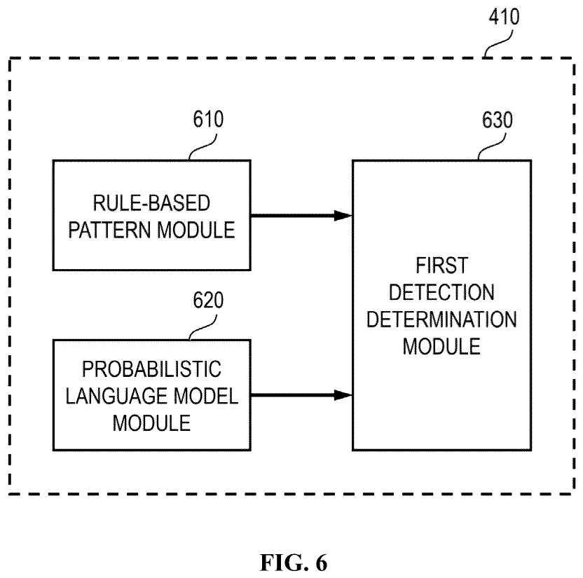

FIG. 6 is a block diagram illustrating a first detection module according to one embodiment of the present disclosure. Referring to FIG. 6, one embodiment of the first detection through the first detection module 410 will be described.

Referring to FIG. 6, the first detection module 410 may include a rule-based pattern module 610, a probabilistic language model module 620, and a first detection determination module 630.

The rule-based pattern module 610 may previously set a rule and determine whether personal information is non-existent based on whether a substring corresponding to the rule exists in the identification target data. For example, when personal information corresponding to the rule is not detected, the rule-based pattern module 610 may determine that personal information is non-existent.

The probabilistic language model module 620 uses a probabilistic language model and calculates the probability of the next word appearing linguistically based on the language context up to a specific word. When the probability of the next word appearing linguistically is greater than a predetermined threshold, that is, when the probability corresponds to a certain probability or higher, this case corresponds to a natural language context and is determined as the non-existence of personal information. However, when it is determined that the probability of the next word appearing linguistically is lower than the predetermined threshold, that is, when the probability of the next word appearing in the language context is low, it may be determined as not corresponding to the non-existence of personal information.

The first detection determination module 630 may determine whether the first detection is performed by reflecting the result of the rule-based pattern module 610 and/or the result of the probabilistic language model-based module 620.

For example, when the result of the rule-based pattern module 610 and the result of the probabilistic language model module 620 are the same—for example, both results are the non-existence of personal information—the first detection determination module 630 may determine whether the first detection is performed with the same result.

In one embodiment, when the result of the rule-based pattern module 610 and the result of the probabilistic language model module 620 are different, the first detection determination module 630 may perform a second detection. This embodiment is intended to enhance the security of personal information.

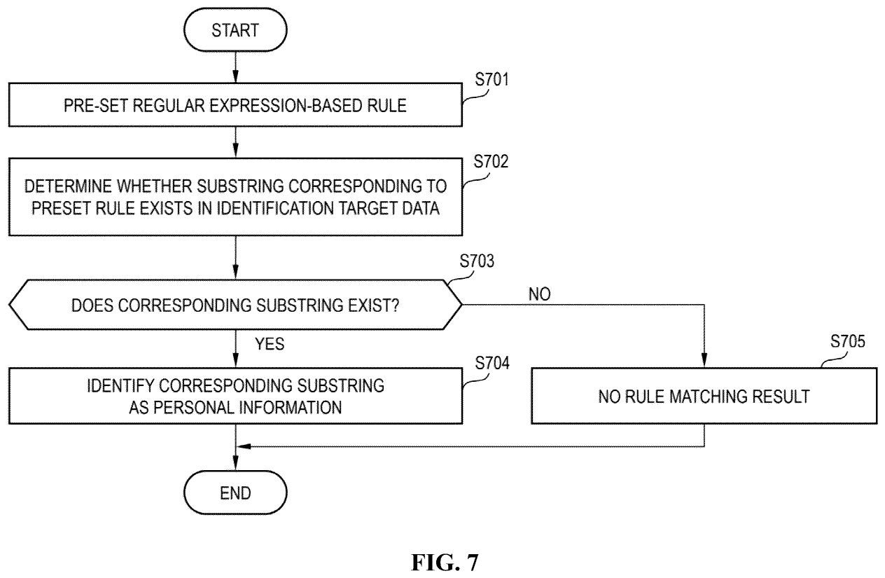

FIG. 7 is a flowchart illustrating an example of a personal information identification method using rule-based detection performed in a first detection module according to one embodiment of the present disclosure. An example illustrated in FIG. 7 describes an example of rule-based detection performed in the rule-based pattern module 610.

The rule-based pattern module 610 may pre-set a regular expression-based rule in operation S701. For example, the rule-based pattern module 610 may define a personal information type to be identified and set a regular expression for each defined personal information type.

For example, the personal information type can be “email address,” “telephone number,” “resident registration number,” “credit card number,” etc., and the regular expression for this can be expressed as follows.

| | |
|---|---|
| Email address | [\w.]+@[\w.-]+\.\w{2,} |
| Telephone number (Korea) | (01[0-9])-?\d{3,4}-?\d{4} |
| Resident registration | \d{2}(0[1-9]\|1[0-2])(0[1- |
| number (Korea) | 9]\|[12][0-9]\|3[01])-[1-4]\d{6} |
| Card number | \d{4}(-\d{4}){3} |

The rule-based pattern module 610 may determine whether a substring corresponding to a preset rule, i.e., a regular expression, exists in the identification target data in operation S702.

When the substring corresponding to the pre-set rule exists (YES in operation S703), the rule-based pattern module 610 may identify the substring as personal information and provide the substring to the first detection determination module 630 in operation S704.

When the substring corresponding to the pre-set rule does not exist (NO in operation S703), the rule-based pattern module 610 may notify the first detection determination module 630 that there is no rule-based matching result, that is, that personal information is non-existent, in operation S705.

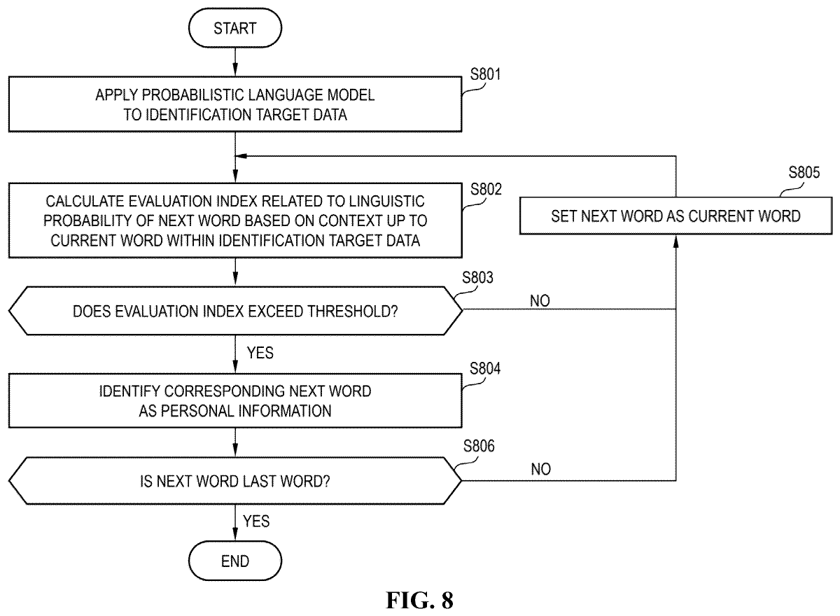

FIG. 8 is a flowchart illustrating an example of a personal information identification method using a probabilistic language model performed in a first detection module according to an embodiment of the present disclosure. The example illustrated in FIG. 8 illustrates an example of detection based on a probabilistic language model performed in the probabilistic language model module 620.

In operation S801, the probabilistic language model module 620 may apply a probabilistic language model to the identification target data.

The probabilistic language model is a model that can predict the probability of the next word appearing linguistically in the text, and can be a well-trained language model for natural language text such as plain text.

The probabilistic language model module 620 may determine whether personal information is non-existent using the probabilistic language model. That is, the method of identifying personal information using the probabilistic language model may be performed based on the naturalness, i.e., probability, of words appearing in the text. Since personal information is in an irregular or unpredictable form compared to the contextual flow of general text, personal information can be detected using a language model.

That is, the probabilistic language model module 620 may calculate an evaluation index related to the linguistic probability of the next word based on the context up to the current word within the identification target data in operation S802.

The probabilistic language model module 620 may identify the next word as personal information in operation S804 when the calculated evaluation index exceeds a threshold (YES in operation S804), for example, when the probability of the next word appearing linguistically is lower than the predetermined threshold.

Meanwhile, when the calculated evaluation index does not exceed the threshold (NO in operation S803), for example, when the probability of the next word appearing linguistically is equal to or greater than the predetermined threshold, the next word is considered not to be personal information, and the next word may be set as the current word in operation S805. Next, this process can be repeated until there is no next word, that is, until the end of the sentence, to identify personal information in operation S806.

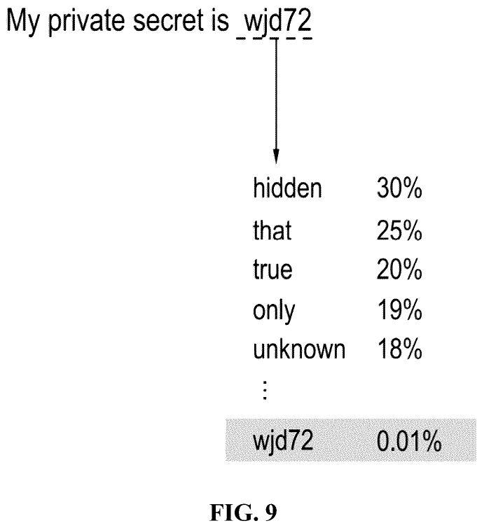

FIG. 9 is a reference diagram illustrating an example of a personal information identification method using a probabilistic language model. Referring to FIG. 9, the probabilistic language model will be described.

Referring to FIG. 9, “My private secret is” is a substring input up to the current word, and the next word is “wjd72.” This is an example in which “wjd72” is provided as personal information for a password.

When receiving a substring up to the current word, “My private secret is,” the probabilistic language model may calculate the probability of the next word appearing linguistically. For example, “hidden” can be calculated as 30%, “that” as 25%, “true” as 20%, “only” as 19%, and “unknown” as 18%. Meanwhile, the probability of the actual next word “wjd72” appearing linguistically is 0.01%, which is significantly low.

The case where the probability of the next word appearing linguistically is equal to or lower than the threshold in the probabilistic language model corresponds to a case where the next word is significantly far from the general context, and the probabilistic language model module 620 may determine that personal information exists in such a case.

In one embodiment, the probabilistic language model module 620 may use perplexity in the probabilistic language model as an evaluation index related to linguistic probability.

The perplexity is one of the performance evaluation indices of a text generation language model. The perplexity is used to determine that the lower the perplexity value, the more predictable the corresponding text is by the language model.

That is, a low perplexity means that the contextual semantics in the language model are excellent, that is, the word is likely to appear in the context, and a high perplexity can be considered to mean that a word is unlikely to appear in the context. In this embodiment, this perplexity can be used as an evaluation index. That is, when the perplexity is high, it can be determined that the word is likely to be personal information.

Perplexity PPL can be calculated as shown in the following Equation 1.

$$PPL ( W ) = {2}^{- \frac{1}{N} {\sum }_{i = 1}^{N} {log}_{2} P ( {w}_{i} \vert {w}_{1} , {w}_{2} , … , {w}_{i - 1} )} \qquad [ Equation 1 ]$$

Here, W denotes a sequence of words in the text, and P(wᵢ|w₁, w₂, . . . , wᵢ₋₁) denotes the probability predicted by the model based on the previous words.

The probabilistic language model module 620 sets a specific threshold based on the perplexity value of each word, and when the perplexity value exceeds this specific threshold, the word or section is determined to be an abnormally predicted word and may be determined as personal information.

In this way, when using the language probability model, whether personal information is non-existent may be determined by reflecting the contextual probability, so that the determination may be performed quickly even in cases that deviate from the rule.

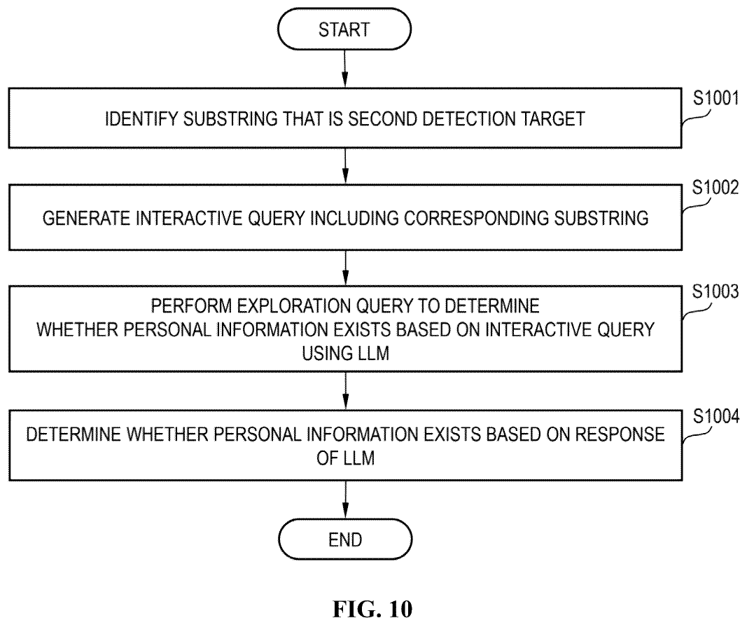

FIG. 10 is a flowchart illustrating an example of a personal information identification method using a large language model (LLM) performed in a second detection module according to one embodiment of the present disclosure.

Referring to FIG. 10, the second detection module 420 will be described in more detail.

In operation S1001, the second detection module 420 may identify a substring that becomes a second detection target from the identification target data. For example, the first detection module 410 may identify a substring in which personal information is determined not to be non-existent.

In operation S1002, the second detection module 420 may generate an interactive query including the substring.

In operation S1003, the second detection module 420 may perform an exploration query on an LLM to determine whether personal information exists based on the generated interactive query.

In operation S1004, the second detection module 420 may determine whether personal information exists based on a response of the LLM.

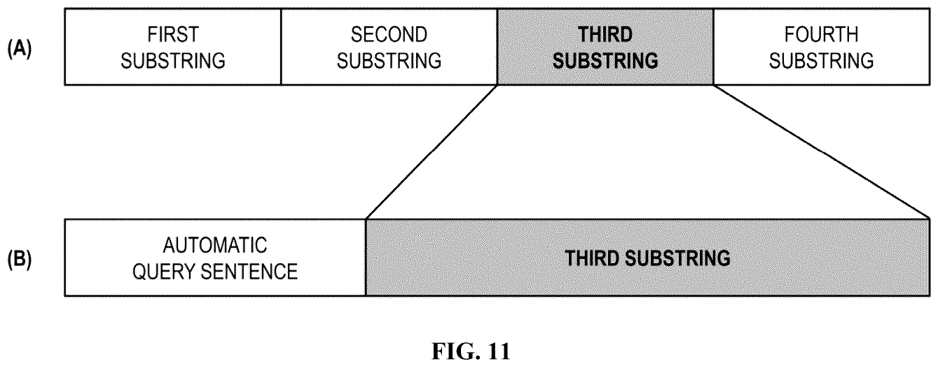

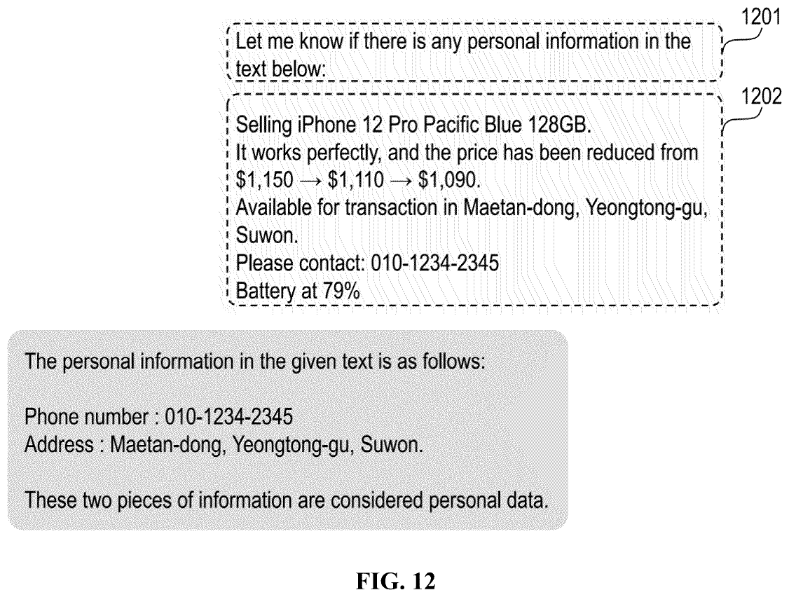

FIGS. 11 and 12 are reference diagrams illustrating examples of a personal information identification method using an LLM. The following description will refer to FIGS. 11 and 12.

FIG. 11 illustrates an example in which the identification target data includes a plurality of substrings. In (A) of FIG. 11, the identification target data includes first to fourth substrings, and it is assumed that the first detection module 410 determines that personal information may exist in the third substring among them.

The second detection module 420 may generate an interactive query that includes the third substring and can be used in an LLM. For example, the second detection module 420 may generate an automatic query sentence, allow the third substring to be the next thereto and thus generate an interactive query including the third substring as shown in (B) of FIG. 11.

FIG. 12 illustrates an example of the automatically generated interactive query and its response of the LLM.

In FIG. 12, an automatic query sentence 1201 “Let me know if there is any personal information in the text below” is generated and a target substring 1202 is included after the generated sentence to provide an interactive query.

In one embodiment, the second detection module 420 may generate an interactive query by reflecting specific data detected by the first detection module 410.

For example, when “101234567” is detected by the first detection module 410, the second detection module 420 may reflect the detected “101234567” in an interactive query. For example, the second detection module 420 may generate an interactive query such as “‘101234567’ appears to be a personal information pattern, please check if there is personal information.”

In another example, when the first detection module 410 detects that corresponding words and numbers are not properly identified in a specific paragraph or location, the second detection module 420 may generate an interactive query such as “There are words and numbers that are hard to read in the third line. Please check if there is personal information.”

In this manner, by identifying personal information using the LLM, it is possible to perform determination with a high level of accuracy similar to that of a human, but in this case, it takes time due to query and response delays. In various embodiments of the present disclosure, by using this method of using the LLM as a secondary method, it is possible to ensure not only the search accuracy of personal information but also the search speed thereof.

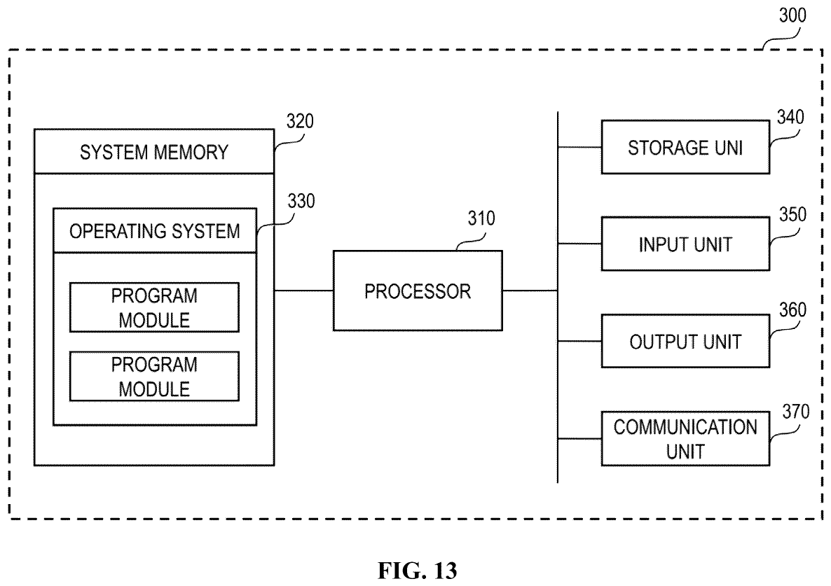

FIG. 13 is a block diagram illustrating a server according to one embodiment of the present disclosure.

FIG. 13 illustrates an example in which a server is used as a personal information identification apparatus, and a server 300 may include one or more of a system memory 320 including an operating system 330, a processor 310, a storage unit 340, an input unit 350, an output unit 360, and a communication unit 370.

The system memory 320 may include a random access memory (RAM) and provide a temporary storage space where the operating system and program modules are executed. The system memory 320 may temporarily store data and instructions and allow the processor 310 to quickly access and process data.

The operating system 330 may include software. The operating system includes memory management, file system management, processor management, and device management, and may control programs executed within the device. The operating system 330 may include a program module, and the program module is a software module for performing a specific function and may provide or be in charge of a user interface or a network.

The processor 310 may include, but is not limited to, a CPU. The processor 310 may execute instructions stored in the system memory 320 and process input data to generate results or perform calculation operations.

The storage unit 340 may include a device that permanently stores data and programs.

The input unit 350 is a device that receives data from a user or another system, and may include a keyboard, a mouse, a touch screen, or a display panel including a touch panel.

The output unit 360 is a device that transmits data processed by the processor 310 to a user or another system, and may include a monitor, a speaker, or a display panel.

The communication unit 370 may enable the server 300 to be communicatively connected to an external network or another device (e.g., a similar semantic content search device 100).

According to various embodiments of the present disclosure, the personal information identification apparatus may be coupled to a computer (or computing device) as hardware and may include a computer program stored on a computer-readable recording medium to perform the operations described in the drawings as examples.

In addition, the personal information identification apparatus may be implemented as a computing device including at least one processor that executes instructions of programs loaded into a memory, and a program including the instructions described to execute operations described with reference to the above-described drawings may be loaded into the memory.

The above-described apparatus may be implemented as a hardware component, a software component, and/or a combination of the hardware component and the software component. For example, the apparatus and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing instructions and responding to the instructions. The processing device may execute an operating system (OS) and one or more software applications executed on the OS. In addition, the processing device may access, store, manipulate, process, and generate data in response to the execution of the software. For ease of understanding, the processing device is sometimes described as being used alone, but those skilled in the art will recognize that the processing device may include multiple processing elements and/or multiple types of processing elements. For example, the processing device may include multiple processors, or one processor and one controller. Other processing configurations, such as parallel processors, are also possible.

Software may include a computer program, code, instructions, or a combination of one or more of these, and may configure a processing device to perform a desired operation or may command the processing device independently or collectively. Software and/or data may be permanently or temporarily embodied in any type of machine, component, physical device, virtual equipment, computer storage medium or device, or transmitted signal wave, for interpretation by the processing device or for providing instructions or data to the processing device. The software may be distributed on a computer system connected via a network and stored or executed in a distributed manner. The software and data may be stored on one or more computer-readable recording media.

The method according to the embodiment may be implemented in the form of program commands that can be executed through various computer means and recorded on a computer-readable medium. The above computer-readable medium may include program commands, data files, data structures, etc., alone or in combination. The program commands recorded on the medium may be specially designed or configured for the present disclosure or known and available to computer software engineers. The computer-readable recording medium includes, for example, magnetic media such as a hard disk, a floppy disk and a magnetic tape, optical media such as CD-ROM and DVD, or magneto-optical media such as a floptical disk, hardware devices such as a ROM, a RAM and a flash memory, specially configured to store and perform program commands, or the like. The program commands include not only machine codes made by a compiler but also high-level language codes executable by a computer by using an interpreter. The hardware device may be configured to operate as at least one software module to perform the operations of the present disclosure, or vice versa.

As described above, according to various embodiments of the present disclosure, by utilizing a pattern matching technique and an LLM in a multi-stage combination, it is possible to quickly and accurately identify personal information based on a multi-stage analysis.

According to various embodiments of the present disclosure, by applying a detection pattern matching method as the first detection, non-personal information can be quickly identified in the first detection and the corresponding information can be passed without the second detection operation, thereby allowing a large number of pieces of non-personal information to be quickly identified and provided to greatly improve the perceived speed of personal information identification.

According to various embodiments of the present disclosure, by utilizing the LLM as the second detection to identify personal information, even personal information that deviates from a specific pattern can be accurately identified as personal information.

According to various embodiments of the present disclosure, by performing the first detection by configuring multiple pattern detection methods in combination, the accuracy of identifying personal information can be improved based on multi-stage combinatorial detection without being limited to a specific detection method.

The effects that can be obtained from the present disclosure are not limited to the effects mentioned above, and other effects that are not mentioned can be clearly understood by a person having ordinary knowledge in the technical field to which the present disclosure belongs from the description below.

Although the embodiments described above have been described with reference to a limited number of drawings, those skilled in the art may apply various technical modifications and variations based on the above. For example, even if the described techniques are performed in a different order than the described method, and/or components of the described systems, structures, devices, circuits, etc., are combined in a different manner than the described method, or replaced or substituted by other components, appropriate results can be achieved.

Therefore, other implementations, other embodiments, and equivalents to the claims are also included in the scope of the claims described below.

Although the detailed description of this document has described specific embodiments, it will be obvious to those skilled in the art that various modifications are possible without departing from the scope of this document.

What is claimed is:

1. A text-based personal information identification method utilizing multi-stage detection, comprising:
receiving identification target data including text;
performing a first detection to determine whether personal information is non-existent in the identification target data based on pattern matching;
allowing the identification target data to pass when it is determined in the first detection that the personal information is non-existent; and
performing a second detection to determine whether personal information exists in the identification target data using a large language model (LLM) when it is determined in the first detection that the personal information is not non-existent.

2. The text-based personal information identification method of claim 1, further comprising:
performing post-processing for security on the personal information when it is determined that the personal information is included in the identification target data according to a result of the second detection.

3. The text-based personal information identification method of claim 1, wherein the performing of the first detection includes applying a probabilistic language model to the identification target data to determine whether personal information is non-existent in the identification target data.

4. The text-based personal information identification method of claim 3, wherein the applying of the probabilistic language model to the identification target data to determine whether personal information is non-existent in the identification target data includes:
calculating an evaluation index for a next word based on the context up to a current word of the identification target data using the probabilistic language model, the evaluation index being an evaluation index related to linguistic probability; and
identifying the next word as personal information when the evaluation index exceeds a predetermined threshold.

5. The text-based personal information identification method of claim 4, wherein the applying of the probabilistic language model to the identification target data to determine whether personal information is non-existent in the identification target data includes setting the next word as the current word when the evaluation index does not exceed the predetermined threshold.

6. The text-based personal information identification method of claim 4, wherein the evaluation index is perplexity in the probabilistic language model.

7. The text-based personal information identification method of claim 3, wherein the performing of the first detection further includes determining whether personal information is non-existent in the identification target data using a regular expression-based rule.

8. The text-based personal information identification method of claim 7, wherein the determining of whether personal information exists in the identification target data using a regular expression-based rule includes:
pre-setting the regular expression-based rule;
determining whether a substring corresponding to a predetermined rule exists in the identification target data; and
identifying the substring as personal information when it is determined that the substring exists in the identification target data.

9. A text-based personal information identification apparatus, comprising:
at least one processor; and
a memory configured to store instructions,
wherein the instructions, when individually or collectively executed by the at least one processor, cause the processor to:
receive identification target data including text;
perform a first detection to determine whether personal information is non-existent in the identification target data based on pattern matching;
allow the identification target data to pass when it is determined in the first detection that the personal information is non-existent; and
perform a second detection to determine whether personal information exists in the identification target data using an LLM when it is determined in the first detection that the personal information is not non-existent.

10. A computer-readable storage medium in a storage medium that stores computer-readable instructions, wherein the instructions, when executed by a computing device, cause the computing device to perform operations of:
receiving identification target data including text;
performing a first detection to determine whether personal information is non-existent in the identification target data based on pattern matching;
allowing the identification target data to pass when it is determined in the first detection that the personal information is non-existent; and
performing a second detection to determine whether personal information exists in the identification target data using an LLM when it is determined in the first detection that the personal information is not non-existent.
